(19) United States
(12) Patent Application Publication
(10) Pub. No.: US 2005/0223374 A1
(43) Pub. Date: Oct. 6, 2005

(54) Server side configuration management

(75) Inventors: Andrew J. M. Wishart, Godstone (GB); Stuart J. Gibbons, Crawley (GB); David A. Baker, Didcot (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/518,274

(22) PCT Filed: Jun. 6, 2003
(86) PCT No.: PCT/IB03/02555

§ 371 Date: Dec. 16, 2004

(30) Foreign Application Priority Data
Jun. 21, 2002 (GB) 0214303.0

(51) Int. Cl. G06F 9/44

(52) U.S. Cl. 717/173

(57) ABSTRACT

A method and system for managing differing software configurations of Consumer Electronic (CE) devices (10) having a unique identifier (18) and network communication means (30) is described. Software options (60, 78) for types of CE device are stored in a software configuration database (46) comprising individual configuration records (70) for each identified CE device (10). The identifier (18) enables a configuration server (40) to look up that devices associated configuration record (70) and installable software options, and provide such options for download to a user's device. The server maintains the record according to user choices, and furthermore upgrades, restores or rolls back software configurations for the CE device(s) according to error detection and/or user preference.

### FIELD OF THE INVENTION

The present invention relates to methods for managing the software configurations of consumer electronic devices in which the configurations may differ from device to device, and to corresponding system, apparatus and program code for the same.

### BACKGROUND ART

The convergence of personal computer (PC), internet/web and messaging technologies ensures that future consumer electronic devices (CE devices) will be in some ways as sophisticated as a current day PC, requiring many different software packages for different purposes, or optionally offering different packages for the same function according some user preference in which option to have on their device. The software options comprising packages may be provided by different providers operating in alliance with the manufacturer of the CE device, with a user being able to select individual packages or whole suites of software related to the provider for use on his or her CE device. Once selected, the user will expect the device to maintain itself, upgrading packages as and when they become available and restoring itself in the event of an error. In the personal computer (PC) arena, multiple software configurations comprising software installed in dependence on user preference and/or software provider alliances are commonplace, with the management (upgrading, restoring or changing) of such configurations being delegated to the user.

However, current day CE devices often have a fixed software configuration comprising embedded software (firmware). In a CE device such as a television (TV), a set top box (STB) or a mobile telephone the supplied software is usually determined and installed at manufacture by the manufacturer or together with a service provider in the case of digital television, with few or no options concerning the software being offered to a user. Modern digital CE devices can connect to a network via a telephone, cable or satellite link for example, and upgrade the firmware as a whole. In such a scenario the same software is installed or upgraded for each device, and the central management of such upgrades, or restoring the whole software to a device in the event of an error is relatively simple. Such systems are disclosed in the U.S. Pat. No. 5,940,074 (WebTV Networks Inc, U.S.A.) and within PCT application WO 01/31440 (Koninklijke Philips Electronics N.V.).

However, whilst user management of the software configuration of a device is acceptable to a dedicated and experienced PC user, such a solution is not acceptable to the average CE device customer who expects perhaps some software options allowing limited customisation (choice of ISP, email package, browser, music . . . ) but expresses little or no interest in maintaining the software configuration of the device once the options have been chosen. Additionally, the prior art systems referenced above for centrally managing the update and restore of software of CE devices are only effective when the same software is installed on the same CE devices.

### DISCLOSURE OF THE INVENTION

It is accordingly an object of the present invention to provide an improved method and system for managing the differing software configurations of CE devices.

### SUMMARY OF THE INVENTION

According to a first aspect of the present invention there is provided a method for managing differing software configurations of a plurality of CE devices operable to communicate with a server over a network wherein each CE device includes an identifier for identifying that device to the server; the server having access to storage means storing a configuration record associated with the identified CE device; the configuration record comprising data indicating the software currently installed on the identified CE device and optional software available to that CE device, said method comprising: selecting a plurality of software options for download to the CE device at least partly by reference to the configuration record associated with the device identifier; providing said software options to the device for download over the network; and updating the associated configuration record for that device in dependence on the download of at least one of the software options by the CE device.

According to a second aspect of the present invention there is provided a system for managing differing software configurations of a plurality of CE devices operable to communicate with a server over a network, wherein each CE device includes an identifier for identifying that device to the server, the server having access to storage means storing a configuration record associated with the identified CE device, the configuration record comprising data indicating the software currently installed on that CE device and optional software available to that CE device, and wherein said server comprises means for selecting software options for the CE device at least partly by reference to the configuration record, means for providing said software options to the device for download over the network, and updating means for updating the configuration record for the CE device in dependence on the download of at least one of said software options by the CE device.

The method and system of the present invention provide a user of a CE device with options of software compatible and installable on his device. The choices offered by a service provider, and those selected by the user for download over the network (such as the internet) to his device are recorded in a configuration record associated with that individual device by way of a unique identifier and maintained by a configuration server (computer) operator.

Hence a plurality of configuration records (together forming a configuration record database), each associated with a particular user's CE device and containing information related to software options such as packages currently installed, those previously uninstalled and those compatible with that device and available for download are maintained.

Preferably, the device identifier comprises information relating to CE device type and information uniquely identifying that device. The information relating to device type, model and such like enables the configuration server operator to determine compatible software options for that device type, whilst the information uniquely identifying that individual device (such as production unit number for example) enables the server to create and maintain a configuration record unique to that device.

The provision of a configuration record for each device further enables automatic, or user controlled software upgrades, restores or “roll back to last good configuration” in the event of an error encountered by the CE device, with the configuration server recording the frequency of such events and determining the appropriate software to supply to the CE device in the event of an error.

The recording of such error events, together with the device type information in an identifier and the software configuration indicated in the individual configuration records advantageously enables a configuration server operator to cross reference such information and provide such information to the software providers, thereby enabling a faster bug-fix and upgrade cycle, and enhancing the stability of those CE devices with the relevant software options installed by applying such upgrades automatically.

Advantageously, the configuration record for each device comprises information specifying the download location of software packages within the selected software options. The information may be in the form of a uniform resource locator (URL) specifying the appropriate download server at which the software is provided.

In one system embodiment a CE device in the form of a digital set top box (STB) having a unique device identifier is described, the STB being operable to communicate over a connection via the internet with a configuration server, with the configuration server itself having access to a configuration record database comprising a configuration record for that device.

In another system embodiment a CE device in the form of a mobile telephone having a unique device identifier is described, the phone being operable to communicate with a configuration server via a wireless network and the internet, with the configuration server itself having access to a configuration record database comprising a configuration record for that device. Optionally, the phone may have extra storage means in the form of a miniature hard disk drive, or a small form factor optical (SFFO) disc drive, or solid state flash memory for example with the increased storage capability enabling download of software options according to the present invention.

According to yet further aspects of the present invention, a CE device having a unique identifier, a configuration server having access to a configuration database comprising a configuration record associated with the CE device identifier, together with program code which when run on such devices cause the methods of the invention to be performed are claimed.

The program code may be supplied on a carrier for installation to the server and devices, wherein the carrier may be based on magnetic or optical storage or the carrier may be in a signal form suitable for distributing the program code across a network.

Further features and advantages of the present invention are recited in the attached claims, the disclosure of which is incorporated herein by reference and to which the reader is now directed.

### BRIEF DESCRIPTION OF DRAWINGS

Preferred embodiments of the invention will now be described, by way of example only, and with reference to the accompanying drawings, in which:

FIG. 1 is a schematic of a system implementing the invention wherein the CE device is a set top box.

FIG. 2 is a schematic representation of a CE device identifier having a device type portion m, and a device number n.

FIG. 3 is an illustration of a device type table for device type m.

FIG. 4a depicts a configuration record for a device having an identifier m.n.

FIG. 4b depicts the configuration record for device m.n after a configuration change.

FIG. 5 illustrates an example of an error table associated with the device m.n.

FIG. 6 is a flowchart illustrating software configuration management in the event of a device error.

FIG. 7 is a schematic representation of a system implementing the invention, wherein the CE device is a mobile telephone.

In the drawings the same reference numerals have been used to indicate corresponding features.

### MODES FOR CARRYING OUT THE INVENTION/DETAILED DESCRIPTION

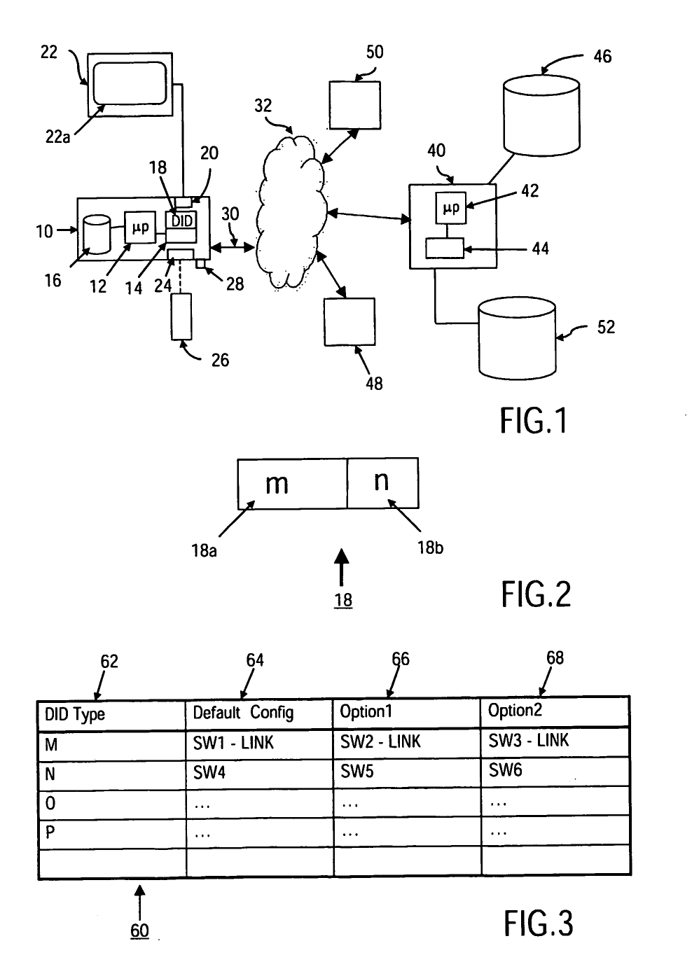

FIG. 1 shows a set top box (STB) 10 having processing means 12 such as a microprocessor or central processing unit, a microcontroller or application specific integrated circuit (ASIC). The processor is enabled to communicate via data and address buses with memory means 14 and non-volatile storage 16 which may be based on magnetic media (hard disc drive HDD, Flash RAM card) or optical media (rewritable compact disc (CD) or digital versatile disc DVD for present day examples) and may be internal to the STB or supplied externally and separately to the STB with suitable connection ports and interface circuitry. The memory means 14 may be any suitable combination of read only (non-volatile) and random access memory, (volatile) and may further comprise electrically erasable non-volatile memory (EEPROM) in for example the form of “Flash-memory” (in which data is written and read in blocks). The memory means stores program code comprising instructions (software) for operating the STB, and also permanently stores in ROM memory a device identifier (DID) 18, the identifier preferably being set by the manufacturer at the time of manufacture. Default application and operating software is provided by the manufacturer and may be provided in Flash memory or alternatively provided in the storage means 16 if available.

The STB comprises Audio/Video (A/V) circuitry 20 for signal output to a display device, in this example a Television (TV) 22 having a display 22a. Additionally the STB 10 comprises input/output (I/O) circuitry 24 to allow user control of the STB via a suitable remote control unit 26 which communicates wirelessly with the STB. User input may also be afforded by press buttons 28 and other suitable input means (touchscreen, touch panel not shown) provided on the STB.

In normal operation the STB provides the user with received digital broadcasts containing movies and TV programmes offered by cable or satellite broadcasters and service providers. The STB is also provided with a connection 30 to a wide area network 32 such as the internet, thus enabling internet and/or satellite services such as shopping, e-mail and enhanced digital text services to be offered to the user. The connection 30 may be activated by providing a modem (not shown) within the STB, the modem connecting to the public switching telephone network (PSTN) and establishing a link with a server on the internet according to TCP/IP protocols well known to those skilled in the state of the art. A default dial-up script stored in memory provides the required information such as a dial-up telephone number and IP address of the default configuration server with which to connect. The default server 40 is a computer having processing means (CPU) 42 and memory 44 and access to a configuration database 46. Server program code for managing the software configurations of connected devices having an identifier (DID) is provided in storage means (such as a hard-disk drive) and when executed by the CPU 42 causes the configuration server 40 to perform software configuration management tasks in co-operation with the CE device 10 and the configuration database 46. Examples of such configuration management tasks will be described in more detail below, but include creating an initial configuration record in the database 46, selecting and offering compatible software packages (software options) for that device, and updating the configuration record in response to download of those options. Compatible software packages may be provided by other computers 48, 50 accessible by the server 40 over the internet 32, with such packages being periodically retrieved by the configuration server 40 and stored in a compatible software database 52 accessible by the configuration server 40.

Alternatively, link data specifying the location of the appropriate download servers 48, 50 hosting the compatible software packages may be stored within the configuration record database 46. In this embodiment the latter option will be described in more detail.

FIG. 2 illustrates a preferred format for the DID 18 permanently stored in the STB 10. The identifier has two portions 18a and 18b. The first portion, denoted ‘m’ in the Figure is defined by the device manufacturer and indicates the model/version of device. Preferably, the first portion comprises an ID string containing for example “STB MODEL M”. Another STB manufactured at a later date and having slightly different capabilities may have the string “STB MODEL N” provided in permanent memory. The second portion of the identifier uniquely identifies that STB unit, for example production run number “1000”, the next STB having an allocated run number of “1001” and so on.

The manufacturer also provides default software configuration information according to the model type (first portion 18a of DID) and also compatible software package information (software options) to the operator of the configuration server 40.

FIG. 3 illustrates such information being provided in the configuration record database 46 in the form of a device type table 60. The first column 62 identifies device type or model and subsequent columns 64, 66, 68 contain information on the default software packages (SW1) provided by the manufacturer and additional information on compatible software options (SW2, 3) for that model. Also provided in table 60 is link data (LINK) for each software option. The link data in this example is in the form of an internet Uniform Resource Locator (URL) specifying the download server 48, 50 at which compatible software packages are available. Alternatively, the link data may simply contain pointers to the appropriate directory or folders in which the software packages are stored if stored locally 52 with respect to the configuration server 40.

The software options 64, 66, 68 may comprise suites of software tailored to available Internet Service Providers (ISP) with which the manufacturer has forged commercial alliances, or each option may denote individual application software choices available to the user of the STB, e.g. a particular choice of CE device compatible web browser or e-mail package may be available.

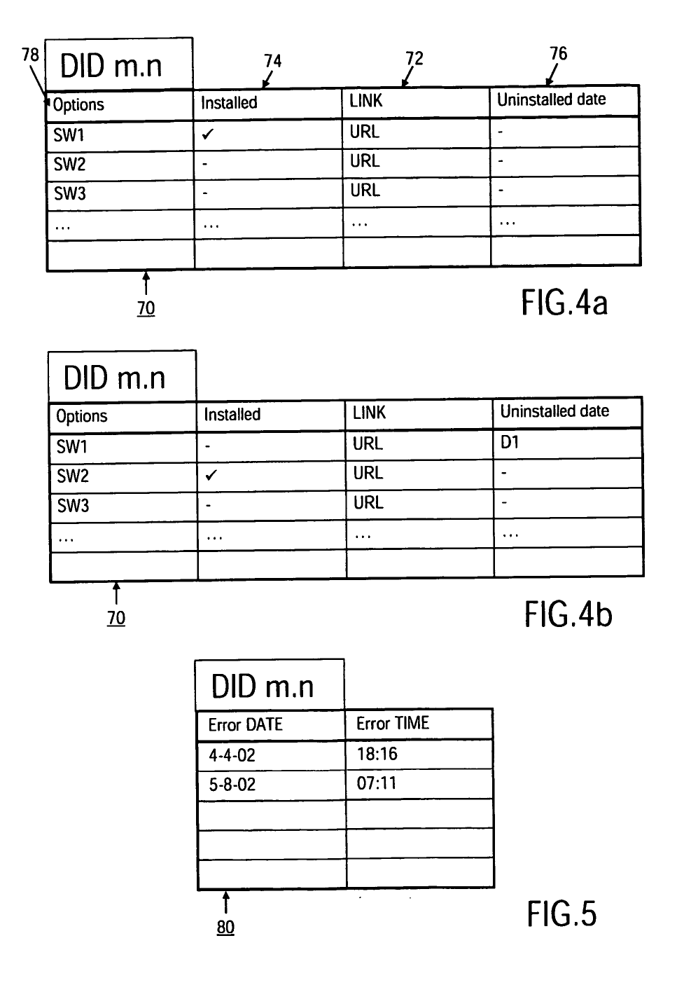

Upon a first connection by the STB 10 to the configuration server 40, the server requests the DID 18 from the STB. The server 40 receives the DID from the STB and the first portion of the DID 18a is cross referenced with the device type table 60 (FIG. 3) stored in the configuration database 46 and an individual configuration record for that device type and individual device (second portion of DID 18b) is created and stored in the database 46 by the configuration server 40. An example of such a configuration record 70 is shown in FIG. 4a, where the record pertains to the DID 18, and data relating to the compatible software options for install are read from the device type table 60 (FIG. 3). The link data is stored in the individual configuration record in a link field 72 as a URL. The currently installed software option is indicated in an ‘install’ field 74 of the record 70. Also recorded in an “uninstall” field 76, is data relating to uninstall or removal of the software option, such as a date of uninstall or overwrite.

Upon subsequent connections by the STB 10 to the configuration server 40, instigated by the processor 12 of the STB 10 according to user input on remote control 26 or button 28, the configuration server retrieves the DID 18 from the STB 10, looks up the associated configuration record 70 and selects and transmits relevant software option information over the net connection 30 with program code executed within the STB by processor 12 causing said option information to be assembled and presented to the user on the TV screen 22a. The user may then navigate to an option and select it for download and install using remote control device 26. The software packages relating to that option are retrieved from the download server via the link data in the configuration record and transmitted to the STB. The software packages may be in binary form and if system software for the STB (upgrades) may be downloaded to particular areas of flash memory, with program code instructions in ROM diverting to the or those particular memory areas according to methods well known to those skilled in the art and as described in U.S. Pat. No. 5,940,074 incorporated herein by reference.

Advantageously, the software option may comprise as described hereinbefore application software such as an alternative e-mail package. Such software may be downloaded and stored in the non-volatile storage 16 of the STB 10. Error checking routines during download (e.g. checksum) may be performed, and upon successful indication of download by the processor of the STB 10, the configuration server 40 updates the configuration record 70 with a date of uninstall and a change in the installed field of the configuration record 70. An example of the updated configuration record after execution of the process described above is illustrated in FIG. 4b wherein software option 2 is indicated within the record as being installed on device DID m.n.

The above embodiment described a user choosing a compatible software package for his device from a selection of compatible software provided in a configuration record table. The advantage of having an individual configuration record 70 for a device 10 will now be described with regard to the use of such a record to restore the current configuration to a device in the event of an error, or to roll back the configuration to that previously installed in the event of repeated errors or a user request.

FIG. 5 depicts an error occurrence table 80 which is related to the STB 10 by way of the unique DID 18, the table being preferably stored in the configuration database 46 and created when the configuration record 70 for that device DID is created. The table is updated with the date and time of connection whenever the STB 10 having that DID flags an error status upon a connection with the configuration server.

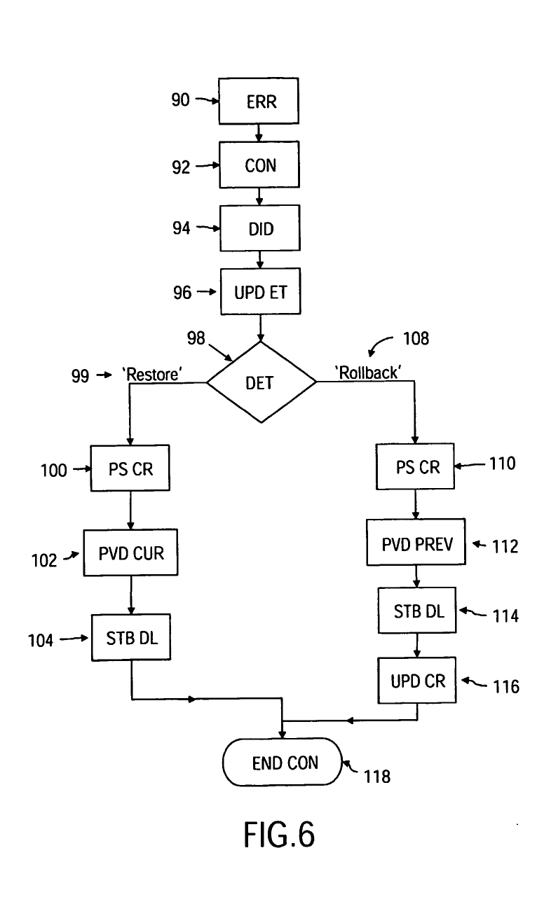

FIG. 6 describes an example process by which the configuration record and associated error table are utilised by the configuration server to restore the currently chosen software to the STB, or to roll back to the previous configuration of software and provide that to the error indicating STB.

The STB processor 12 detects an inconsistent state (for example—a corrupt data block causes a program crash or freeze, requiring the user to reset the device 10 by means of a reset button or by removing power to the device for several seconds).

The reset causes the STB to execute an error routine (step 90) on boot-up, the error routine accessing a default error connection script stored in a boot area of memory means 14. A connection (step 92) to the configuration server 40 according to the error connection script is established, the DID 18 is requested (step 94) by the server 40, and the time and date of connection are recorded in the associated device error table 80 (step 96) stored in the configuration database 46. The server processor 42 then determines (step 98) whether the currently installed software configuration (FIG. 4b) should be restored to the STB 10 or whether the configuration should be rolled back (‘rollback’) to the previous configuration (FIG. 4a). In this example the error table 80 is parsed and the time and date of previous errors are compared against determining criteria. For example, errors separated by time intervals of weeks or months predominantly indicate unrelated software glitches or data corruption within the STB 10, and in this case a ‘restore’ (step 99) is determined as being appropriate with the server parsing (step 100) the configuration record ‘install’ field 74 and link field 72, and providing the software package(s) indicated as being currently installed via the link data in the configuration record (step 102) to the STB which downloads (step 104) the appropriate software packages.

Alternatively, the error may cause the STB 10 to repeatedly reset and connect to the configuration server 40. In this instance the time interval between error connections recorded in the error table will be much shorter, for example only minutes apart despite the restoration of the currently installed configuration. In such instances, at determining criteria step 98 the server CPU is then directed by program code to execute the instructions according to a ‘rollback’ (step 108 FIG. 6). The configuration record is parsed to determine the previously installed software options. For example, with reference to FIG. 4b the server determines that software package 1 was uninstalled/replaced on date D1, and this software is provided (step 112) via the link data to the STB for download (step 114). The configuration record is subsequently updated (step 116) to reflect the execution of the rollback with the uninstall field relating to software option 1 (SW1) being cleared, the appropriate install field 74 of the configuration record indicated, and the date of rollback execution entered in the uninstall field relating to software option 2 (SW2).

Those skilled in the art will recognise that other additional data may be recorded in the configuration record, such as the dates of install of a particular option. Simple comparisons of these other data may offer alternative algorithms for use in the restore (99) or rollback (108) paths of the example flowchart of FIG. 6.

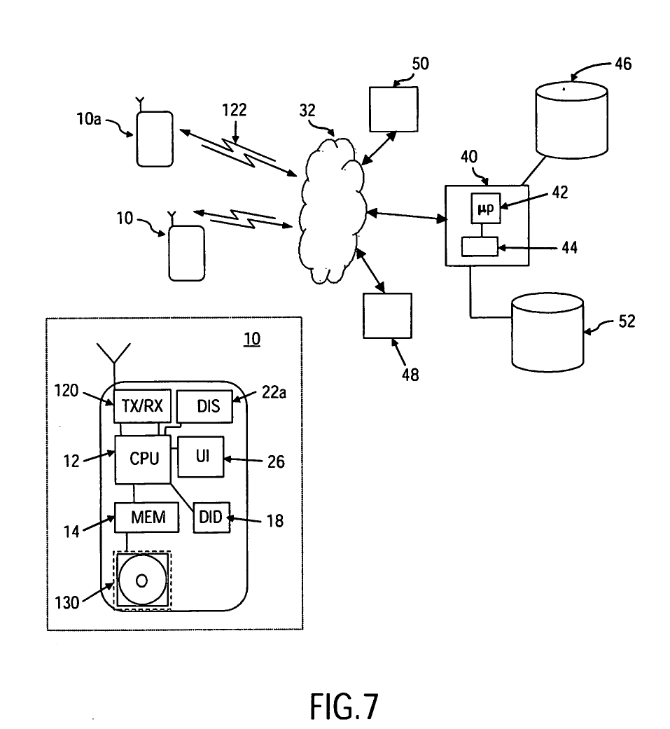

In another embodiment of the present invention, the software configurations of a plurality of CE devices in the form of mobile telephones are managed. FIG. 7 illustrates such a system, with each mobile telephone 10, 10a having (see inset FIG. 7) a unique device identifier 18, a processor 12 for executing program instructions stored in memory 14, a display 22a for displaying output and user input means in the form of keyboard or other suitable means (touchpad, touchscreen) and transmission and reception means 120 for making voice calls and transmitting and downloading software and/or data. The telephone is provided with program code and data for accessing a configuration server 40 over a wireless network 122 (for example in a GSM embodiment connections via network 122 are received by a cellular base station, relayed therein to a mobile switching centre and further relayed to the PSTN and hence the internet 32) according to standards and protocols associated with the wireless network (GSM, GPRS, 3G) and the internet 32. Once connection is established the phone provides the unique identifier 18 to the configuration server.

The configuration server operates as described hereinbefore, identifying the telephone type via the identifier and creating and storing an individual configuration record in the configuration database. The mobile phone is provided with a fixed amount of rewritable storage 14 (for example flash memory) and the user is offered software options concerning the use of this storage. For example, an enhanced calendar application may be selected and offered by the configuration server 42, at the expense of less memory 14 for the phonebook application. The choice of the user is recorded in the associated configuration record for that device and the applications updated or altered as appropriate upon download of the relevant software options comprising program code to the phone memory.

In a further variation of the mobile phone embodiment, a phone is supplied with extra storage capacity 130 in the form of removable miniature hard disk drives such as the IBM microdrive® or a small form factor optical disk drive (SFFO) 130 which accepts compatible optical disk media (inset FIG. 7). The availability of such storage 130 enables extra software options for that model of device to be catered for by the manufacturer, these options being supplied to the configuration server in a device type table 60 and hence offered to a user of that phone using the methods hereinbefore described. In this way the system of this invention enables further phone customisation according to user preference, the customisation being recorded in the configuration database as previously described.

The above examples illustrate the invention automatically reconfiguring a device 10 such as a STB or mobile phone upon error, or upon user request to update or change the software packages currently installed on the device 10. The skilled man will also appreciate that the execution of software package updating, restore or rollback functions according to the methods and principles of this invention may be initiated automatically by, and under the control of the configuration server 40, thereby allowing a network wide software configuration upgrade of all devices having that software configuration as indicated within respective configuration records for those devices. Such a network-wide automatic upgrade to the relevant devices according to records within the configuration database is achieved by the configuration server processor updating the link field of each configuration record to point to the download server hosting the upgraded software.

Additionally, the configuration server may execute program code for monitoring the frequency of error connections by devices, for cross referencing such error data with the software options indicated as being installed upon such devices, and for reporting the data to the software option or package providers, thereby signalling possible configuration conflicts for those device types to the software providers/developers and hence speeding up the detection, reporting and bug fixing of inter-software package compatibility issues. Developers of such packages may pay for such a monitoring service according to individual device configuration within a device type.

In the aforementioned embodiments, a system for software configuration management of a plurality of consumer electronic devices is disclosed. The system advantageously enables some customisation of the devices according to user preference, whilst maintaining and recovering such configurations in the case of error or user request.

From reading the present disclosure, other modifications will be apparent to persons skilled in the art. Such modifications may involve other features which are already known in the design, manufacture and use of systems, CE devices and databases for incorporation therein, and which may be used instead of or in addition to features already described without departing from the spirit and scope of the present invention.

In the present specification and claims the word “a” or “an” preceding an element does not exclude the presence of a plurality of such elements.

1. A method for managing differing software configurations of a plurality of CE devices (10, 10a) communicate with a server (40) a network wherein each CE device includes an identifier (18) dentifying that device to the server, the server having access to storage means (46) storing configuration record (70) associated with the identified CE device (10); the configuration record (70) comprising data indicating the software currently installed on the identified CE device and optional software (78) available to that CE device, said method comprising:
selecting a plurality of software options (64, 66,68) for download to the CE device (10, 10a) at least partly by reference to the configuration record (70) associated with the device identifier;
providing said software options to the device (10, 10a) for download over the network (32);
and updating the associated configuration record (70) for that device in dependence on the download of at least one of the software options by the CE device.

2. A method according to claim 1, wherein the device identifier (18) comprises information relating to CE device type (18a) and information (18b) uniquely identifying that device.

3. A method according to claim 2, wherein the selection of optional software available for download to the CE device is determined partly by device type information (18a) in the identifier (18).

4. A method according to any preceding claim, wherein the download of at least one of the software options by the CE device occurs automatically in response to an error status indicated by the CE device (10, 10a) to the server (40).

5. A method according to claim 4, wherein the software automatically downloaded in response to an error status (90) is selected according to determining criteria (98).

6. A method according to claim 5, wherein the determining criteria relate to the frequency of error status indications by the CE device, the frequency data (80) collected (96) by the server (40) which selects software in dependence on the configuration record (70) and this frequency data.

7. A method according to claim 6, wherein the selected software performs an automatic restore (99), an upgrade, or a roll back (108) of the software indicated within the configuration record.

8. A method according to claim 1, wherein the download of at least one of the software options performs a software upgrade, a restore or a roll back in dependence on user input (26).

9. A method according to any preceding claim, wherein the configuration record (70) is stored in a database (46) comprising a plurality of configuration records, each record being identified with a CE device (10, 10a).

10. A method according to claim 9, wherein the configuration records (70) comprise link data (72) referencing software download locations (48, 50).

11. A system for managing differing software configurations of a plurality of CE devices (10, 10a) operable to communicate with a server (40) over a network (32), wherein each CE device includes an identifier (18) for identifying that device to the server, the server having access to storage means (46, 52) storing a configuration record (70) associated with the identified CE device (10), the configuration record comprising data indicating the software currently installed on that CE device and optional software (78) available to that CE device, and wherein said server comprises means (42) for selecting software options for the CE device at least partly by reference to the configuration record, means (42, 30) for providing said software options to the device for download over the network (32), and updating means (42) for updating the configuration record (70) for the CE device in dependence on the download of at least one of said software options by the CE device.

12. A system according to claim 11 wherein the software for download is stored (48, 50) remote to said server (40), the configuration record comprises link data (72) signifying the relevant remote storage location, and wherein the providing means provides said link data to the CE device to enable download of software by the CE device.

13. A system according to claim 11, wherein the download of software by the CE device (10,10a) is initiated automatically by the server (40).

14. A system according to claim 11 or claim 12, wherein the download of software by the CE device is initiated in response to user input (26) to the CE device.

15. A system according to claim 11, wherein the CE device comprises means (12) for detecting an internal error and means (30) for connecting to the server (40) in response to said detection and the server comprises determining means (42) which determine software for automatic download to the CE device according at least in part to error criteria (80) and at least in part by reference to the software configuration record (70) for that CE device.

16. A CE device (10, 10a) for use with the system of claim 11, the device comprising ID memory means (14) for storing a device identifier (18), storage means (16) for storing software, input means (24, 26) for receiving input and processing means (12) for processing said software, the device being operable to receive downloads according to a configuration record (70) across a network (32).

17. A server (40) for use with the system of claim 11, comprising storage means (46; 52) for storing a configuration record (70) for each identified CE device.

18. Program code which when executed on the system of claim 11 provides means for selecting software for download to a CE device (10, 10a) at least in part by reference to a configuration record (70) associated with the CE device, means for providing said software to the CE device for download over a network, and means for updating the configuration record for the CE device in dependence on the download of said software by the CE device.

19. Program code which when executed by processing means (12, 42) in a configuration management system cause the steps of any one of method claims 1 to 10 to be carried out.

20. A program code product wherein the program code according to claim 18 or claim 19 is provided on a carrier.

21. A configuration record database (46, 52) for use with the system of claim 11 comprising a plurality of configuration records (70), each of which records is associated with a CE device by means of an identifier (18) stored within said CE device.

22. A database according to claim 21, wherein at least one configuration record (70) associated with an identified CE device comprises data fields (72, 78) relating to software available for download to said identified CE device.

23. A database according to claim 22, wherein the data fields comprise download location data (72) for the software.
